(19) United States
(12) Patent Application Publication
(10) Pub. No.: US 2002/0172471 A1
(43) Pub. Date: Nov. 21, 2002

(54) Precise self-aligning split-sleeve fiber-optic bulkhead connector

(76) Inventors: Joseph B. Slater, Dexter, MI (US); Thomas P. Ryan, Ann Arbor, MI (US)

Correspondence Address: John G. Posa, Gifford, Krass, Groh, Sprinkle,, Anderson & Citkowski, P.C., 280 N. Old Woodward Ave., Suite 400, Birmingham, MI, 48009-5394, US

(21) Appl. No.: 10/105,656

(22) Filed: Mar. 25, 2002

Related U.S. Application Data
(60) Provisional application No. 60/278,226, filed on Mar. 23, 2001.

(51) Int. Cl. G02B 6/36; G02B 6/38

(52) U.S. Cl. 385/78; 385/60

(57) ABSTRACT

A bulkhead-style connector incorporates a fixed, split sleeve to accurately and repeatably position a fiber-optic ferrule with respect to a housing. The split sleeve, which may be made of metal or ceramic, is attached in a manner allowing the sleeve to slightly expand. This allows the sleeve to locate the ferrule precisely, while still providing a controlled insertion and extraction force in the presence of a low level of contaminants. The split sleeve may be accurately located either by bonding it tangentially in a manner that enables the sleeve to expand, or by surrounding the sleeve with a material having a low modulus of elasticity enables the sleeve to expand. As a further option the sleeve may be bonded in a localized area and surrounded with low-modulus material elsewhere to provide a bonded and sealed configuration. The sleeve may optionally incorporate raised sections on its internal diameter, to better locate the fiber optic ferrule, and to provide increased clearance between the majority of the sleeve's inner diameter and the outer diameter of the ferrule. Such a configuration may further help to minimize the introduction of contaminants. The housing may also incorporate a window to isolate the fiber optic ferrule from the opposite side of the housing.

### REFERENCE TO RELATED APPLICATION

This application claims priority to U.S. provisional patent application Serial No. 60/278,226, filed Mar. 23, 2001, the entire contents of which being incorporated herein by reference.

### BACKGROUND OF THE INVENTION

There are many situations wherein an optical fiber must interface to a housing or equipment by way of a bulkhead-type connector. In such cases it is important not only to maintain alignment, but also to establish a contaminant-free connection that is easy to use and re-use.

Current optical fiber connector sleeve/housing designs use a metal or ceramic sleeve to locate the ferrule to a tolerance of a micron or so. The accuracy of the location is necessary to either couple the light beam carried by the optical fiber inside the ferrule to another fiber with minimal losses, or to position the light which traverses the fiber in close relation to an external optical system.

The current designs accomplish this through the use of a close-fitting cylinder to surround the ferrule, with perhaps a micron or so of clearance. One problem with the current design is that any contamination, particularly in the form of dust particles, can cause the ferrule to jam in the solid sleeve.

There are a couple of companies, namely Wave Optics of Hillsboro, Oreg. USA and Oz Optics of Ontario, Calif. that make a fiber optic to free space coupler. Again, however, these rely on very tight tolerances between the shrouding around the fiber and the ferrule. A stable material such as zirconia is used to provide a very tight tolerance such that when the male portion is physically aligned to the female portion in a very accurate way.

These and other companies also provide fiber-to-fiber connectors, certain of which use a split-sleeve arrangement. The sleeve, also typically of zirconia and typically a half-inch (0.625) in length, is contained within a body into which the ferrules of the fibers to be joined are inserted. As one example, U.S. Pat. No. 4,892,379 discloses an adaptor for a fiber optic connector of the type which utilizes a split sleeve to align ferrules from oppositely facing connectors. The sleeve has a longitudinal slit and the ferrules receive the optical fiber. A tubular shaped elastic body is installed around the outer periphery of the split sleeve, the body applying a spring force to the periphery of the split sleeve.

### SUMMARY OF THE INVENTION

Broadly, this invention makes use of a fixed, split sleeve to accurately and repeatably position a fiber-optic ferrule with respect to a housing. In the preferred embodiment the sleeve is contained within a connector having a land for attachment to the wall of the housing, though the technique is applicable to other configurations including FC, modified FC, and other styles, with and without a land.

The split sleeve, which may be made of metal or ceramic, is attached to the housing in a manner allowing the sleeve to slightly expand. This allows the sleeve to locate the ferrule precisely, while still providing a controlled insertion and extraction force in the presence of a low level of contaminants.

The split sleeve may be accurately located either by bonding it tangentially in a manner that enables the sleeve to expand, or by surrounding the sleeve with a material having a low modulus of elasticity enables the sleeve to expand. As a further option the sleeve may be bonded in a localized area and surrounded with low-modulus material elsewhere to provide a bonded and sealed configuration.

The sleeve may optionally incorporate raised sections on its internal diameter, to better locate the fiber optic ferrule, and to provide increased clearance between the majority of the sleeve's inner diameter and the outer diameter of the ferrule. Such a configuration may further help to minimize the introduction of contaminants. The housing may also incorporate a window to isolate the fiber optic ferrule from the opposite side of the housing.

### BRIEF DESCRIPTION OF THE DRAWINGS

FIG. 1A is a drawing which shows a tangentially bonded split sleeve according to the invention;

FIG. 1B is a drawing of the embodiment of FIG. 1A shown from an oblique perspective;

FIG. 1C is a simplified drawing illustrating an alternative location for the location of the bonded outer sleeve, namely, closer to the opening of the split;

FIG. 2A is a perspective-view drawing of a split-sleeve connector according to the invention in a connector body without a land;

FIG. 2B is a perspective-view drawing of the opposing side of the connector of FIG. 2A, showing the way in which the central bore may contain a hermetically sealed window to reduce contamination;

FIG. 3 is a simplified end-view drawing illustrating the way in which a material having a low modulus of elasticity may be disposed between an inner split sleeve and an outer sleeve or bore to provide a connector according to the invention; and

FIG. 4 is an oblique drawing of a split sleeve according to the invention having one or more raised areas to assist with positioning of the ferrule.

### DETAILED DESCRIPTION OF THE INVENTION

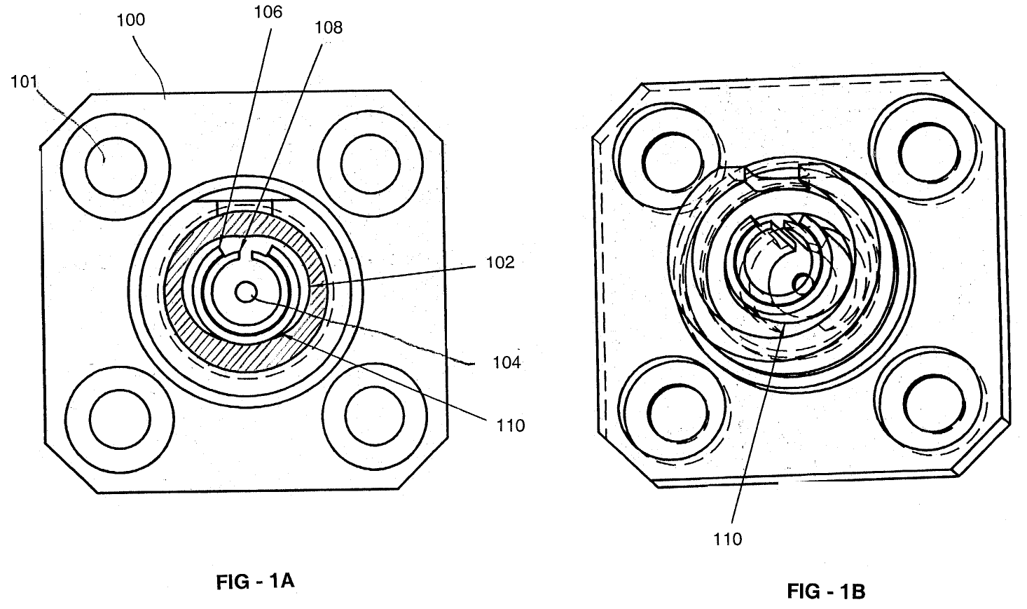

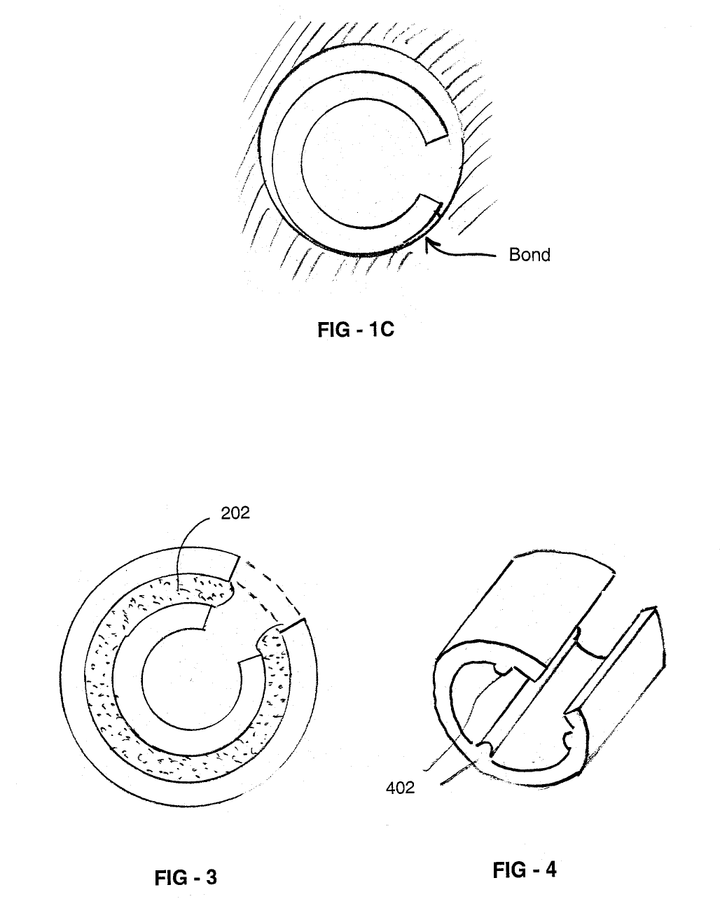

As discussed in the Summary, this invention makes use of a fixed, split sleeve to accurately and repeatably position a fiber-optic ferrule with respect to a housing. Reference is now made to the figures, wherein FIGS. 1A and 1B illustrate a preferred embodiment of the invention configured as an FC-type of connector with a land 100 and mounting holes 101. Central to the structure is a bore 102 designed for flex clearance. Central to the bore 102 and the connector overall, is an aperture 104 through which light is conducted when a fiber-optic ferrule (not shown) of standard design and dimensions is inserted.

The ferrule is received by an inner split sleeve 108 which is surrounded by an outer sleeve 106. The outer sleeve 106 is also preferably split, though in a manner wider than that of the inner split sleeve 108 to allow for expansion. In the preferred embodiment, the inner sleeve is a ceramic such as zirconia, valued for its dimensionally precision, though other materials may be used, including metals and alloys, such as phosphor-bronze, beryllium-copper, and other materials. The outer sleeve 106 is preferably a metal such as brass or stainless steel, though other metals, alloys and perhaps ceramics may be useful for such purpose. Note that the volume 109 between the outer surface of the outer sleeve 106 and the inner surface of the bore 102 may be filled with a low-modulus material such as epoxy or Silastic® to adjust for the stiffness of the split sleeve 108, to keep out contaminants, or to create a wiper lip to clean the fiber ferrule.

While the split sleeve 108 may be held within the outer sleeve 106 through the friction of intimate contact, the outer sleeve 106 must be bonded to the inner surface of the bore 102 at some point around its periphery. In the configuration of FIG. 1A, the sleeve 106 is bonded to the inner surface of the bore at point 110, though, as shown in FIG. 1C, the outer sleeve 106 may be bonded at a different point, namely, at a point closer to the opening of the split in the sleeve itself. Any suitable soldering or brazing technique may be used, as appropriate to the materials.

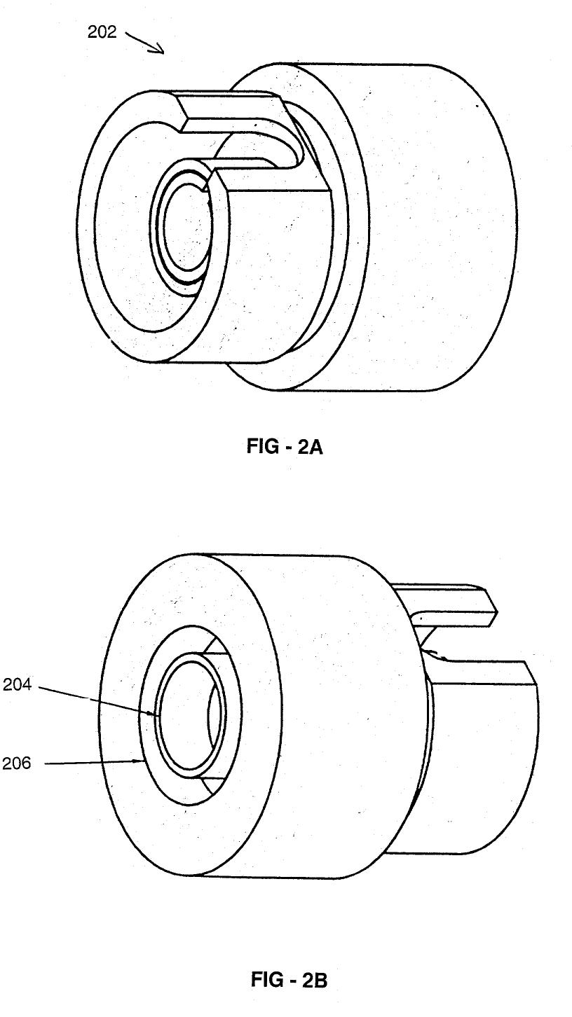

FIGS. 2A and 2B show first that the invention is applicable to other types of connectors 202 which do not use lands, and secondly, to an alternative embodiment wherein central bore 204 is configured to contain a hermetically sealed window. In such a configuration, the window surround 206 is preferably recessed for stress relief on the glass, sapphire or whatever other transparent or semi-transparent material is used.

As an alternative to the inner split sleeve engaging with a very close tolerance frictional fit with the outer sleeve, as shown in FIG. 3, there may be a space between the two sleeves which is preferably filled with a low-modulus material which is stiff enough to spread somewhat while keeping the center of the ferrule aligned relative to the aperture (i.e., 104) through the connector body. Indeed, depending upon the low-modulus material, the inner split sleeve may be disposed with a central bore (i.e., 102) without an outer sleeve, as depicted with the broken lines of FIG. 3.

As yet a further option, as shown in FIG. 4, particularly the inner splits sleeve may include one or more longitudinal raised ribs (402) to better locate the fiber optic ferrule and/or to provide increased clearance between the majority of the inner diameter of the split sleeve and the outer diameter of the ferrule to enhance positioning accuracy despite repeated installation and removal.

What has been shown and described is a precise, self-aligned split sleeve bulkhead-type connector to receive a fiber-optic ferrule, which meets various criteria in terms of positional accuracy and insertion of repeatability. Through the use of the invention, when a ferrule is inserted into the connector, the inner split sleeve begins to flex, and continues to flex slightly as the ferrule is inserted until it bottoms out within the sleeve. The desired insertion pressure depends upon the type of connector. For example, an FC ferrule typically exhibits a spring-loaded preset to 2 pounds, and will stick at that or above. Thus a maximum insertion pressure range of substantially less than value, one the order of a half-pound or less, would be appropriate.

We claim:

1. A connector for receiving a fiber-optic ferrule having an outer diameter, comprising:
a connector body having a central bore with an inner surface extending partially though the body and terminating in an end wall;
an aperture extending through the end wall of the central bore to carry light from the fiber optic through the body; and
an inner split sleeve supported within the bore, the inner split sleeve having an outer surface and an inner diameter corresponding to the outer diameter of the fiber-optic ferrule.

2. The connector of claim 1, further including an outer sleeve surrounding the inner split sleeve within the central bore, the outer sleeve hiving an inner surface and an outer surface that is bonded at least at a point to the inner surface of the central bore.

3. The connector of claim 2, wherein:
the outer sleeve is also split; and
the split of the inner and outer sleeves are aligned to one another.

4. The connector of claim 2, wherein the outer surface of the inner sleeve corresponds to the inner surface of the outer sleeve thereby providing a close-tolerance frictional fit.

5. The connector of claim 1, wherein a substance having a low modulus of elasticity is disposed between the outer surface of the inner sleeve and the inner surface of the bore.

6. The connector of claim 2, further including a substance having a low modulus of elasticity disposed within the outer surface of the outer sleeve and the inner surface of the central bore.

7. The connector of claim 6, wherein the substance having the low modulus of elasticity is an epoxy material.

8. The connector of claim 1, wherein the inner sleeve is a ceramic, metal or metal alloy.

9. The connector of claim 2, wherein the outer sleeve is a ceramic, metal or metal alloy.

10. The connector of claim 2, wherein the outer surface of the outer sleeve is bonded to the inner surface of the central bore.

11. The connector of claim 2, wherein the outer surface of the outer sleeve is brazed or soldered to the inner surface of the central bore.

12. The connector of claim 2, wherein:
the outer sleeve is split; and
the outer surface of the outer sleeve is bonded to the inner surface of the central bore at a point generally opposite to the slit in the outer sleeve.

13. The connector of claim 2, wherein:
the outer sleeve is split; and
the outer surface of the outer sleeve is bonded to the inner surface of the central bore at a point proximate to the slit in the outer sleeve.

14. The connector of claim 1, wherein the connector body further includes a land for bulkhead mounting.

15. The connector of claim 1, further including a window covering at least the aperture through the body.

16. The connector of claim 1, wherein the connector body conforms to an FC-style connector.

17. A receptacle configuration within a connector for receiving a fiber-optic ferrule having an outer diameter, the connector including a connector body having a central bore with an inner surface extending partially though the body and terminating in an end wall, and an aperture extending through the end wall of the central bore to carry light from the fiber optic through the body, the receptacle configuration comprising:
an outer sleeve disposed within the central bore, the outer sleeve hiving an inner surface and an outer surface that is bonded at least at a point to the inner surface of the central bore; and
an inner split sleeve disposed within the outer sleeve, the inner split sleeve having an outer surface and an inner diameter corresponding to the outer diameter of the fiber-optic ferrule.

18. The connector of claim 17, wherein:
the outer sleeve is also split; and
the split of the inner and outer sleeves are aligned to one another.

19. The connector of claim 17, wherein the outer surface of the inner sleeve corresponds to the inner surface of the outer sleeve thereby providing a close-tolerance frictional fit.

20. The connector of claim 17, wherein:
the outer surface of the inner sleeve is spaced apart from the inner surface of the outer sleeve; and
a substance having a low modulus of elasticity is disposed within the outer surface of the inner sleeve and the inner surface of the outer sleeve.

21. The connector of claim 20, wherein the substance having the low modulus of elasticity is an epoxy material.

22. The connector of claim 17, further including a substance having a low modulus of elasticity disposed within the outer surface of the outer sleeve and the inner surface of the central bore.

23. The connector of claim 22, wherein the substance having the low modulus of elasticity is an epoxy material.

24. The connector of claim 17, wherein the inner sleeve is a ceramic, metal or metal alloy.

25. The connector of claim 17, wherein the outer sleeve is a ceramic, metal or metal alloy.

26. The connector of claim 17, wherein the outer surface of the outer sleeve is bonded to the inner surface of the central bore.

27. The connector of claim 17, wherein the outer surface of the outer sleeve is brazed or soldered to the inner surface of the central bore.

28. The connector of claim 17, wherein:
the outer sleeve is split; and
the outer surface of the outer sleeve is bonded to the inner surface of the central bore at a point generally opposite to the slit in the outer sleeve.

29. The connector of claim 17, wherein:
the outer sleeve is split; and
the outer surface of the outer sleeve is bonded to the inner surface of the central bore at a point proximate to the slit in the outer sleeve.

30. The connector of claim 17, wherein the connector body further includes a land for bulkhead mounting.

31. The connector of claim 17, further including a window covering at least the aperture through the body.

32. The connector of claim 17, wherein the connector body conforms to an FC-style connector.
